(19) United States
(12) Patent Application Publication
(10) Pub. No.: US 2023/0130429 A1
(43) Pub. Date: Apr. 27, 2023

(54) METHOD FOR DEBUGGING PROGRAM OF MANYCORE PARALLEL PROCESSOR BASED ON CODE EXECUTION AND APPARATUS USING THE SAME

(71) Applicant: ELECTRONICS AND TELECOMMUNICATIONS RESEARCH INSTITUTE, Daejeon (KR)

(72) Inventor: Joo-Hyun LEE, Daejeon (KR)

(73) Assignee: ELECTRONICS AND TELECOMMUNICATIONS RESEARCH INSTITUTE, Daejeon (KR)

(21) Appl. No.: 17/972,116

(22) Filed: Oct. 24, 2022

(30) Foreign Application Priority Data
Oct. 25, 2021 (KR) 10-2021-0142427
Jul. 6, 2022 (KR) 10-2022-0083165

(51) Int. Cl. G06F 11/36; G06F 11/07

(52) U.S. Cl. CPC G06F 11/3636; G06F 11/3656; G06F 11/0772

(57) ABSTRACT

Disclosed herein are a method for debugging a program of many core parallel processors based on code execution and an apparatus for the same. The method, performed by debugger software running on a host processor, includes generating a program execution binary including debug execution code and providing the same to multiple parallel processors, acquiring context data corresponding to the state of a target processor immediately before the debug execution code is executed in the target processor, among the multiple parallel processors, and analyzing the context data and thereby performing debugging of a program executed in the processor in which the debug execution code is executed.

### CROSS REFERENCE TO RELATED APPLICATIONS

This application claims the benefit of Korean Patent Application No. 10-2021-0142427, filed Oct. 25, 2021, and No. 10-2022-0083165, filed Jul. 6, 2022, which are hereby incorporated by reference in their entireties into this application.

### BACKGROUND OF THE INVENTION

### 1. Technical Field

The present disclosure relates generally to technology for debugging a program of many core parallel processors based on code execution, and more particularly to technology for debugging a program that is executed in parallel processors for operation processing in a many core-parallel-processor system in which a large number of parallel processors is used in order to accelerate an enormous amount of operation processing.

### 2. Description of the Related Art

In an existing single processor, a hardware debug module is implemented in a chip for debugging, and debugging is supported through communication with debugger software in an external host.

FIG. 1 illustrates a block diagram of a hardware debug module of a RISC-V processor. As shown in FIG. 1, a processor includes a Debug Transport Module (DTM) for communicating with external debugger software and a Debug Module (DM) for controlling debugging of the processor, and a debug mode and a hardware trigger module for setting a breakpoint or the like are designed and implemented in a processor core (RISC-V core).

However, in the case of a large-scale parallel processor system using thousands and more processors, the implementation area of a debug module is non-negligibly increased when it is implemented in hardware, and because the frequency of actual use of the debug module is low, the efficiency of chip design may decrease.

### DOCUMENTS OF RELATED ART

(Patent Document 1) Korean Patent Application Publication No. 10-2018-0054773, published on May 24, 2018 and titled “Debugging method, multi-core processor, and debugging equipment”.

### SUMMARY OF THE INVENTION

An object of the present disclosure is to debug a program of each of parallel processors without a hardware debug module in a large-scale parallel system in which thousands and more processors are used.

In order to accomplish the above object, a method for debugging a program of many core parallel processors based on code execution, which is performed by debugger software running on a host processor, according to the present disclosure includes generating a program execution binary including debug execution code and providing the same to multiple parallel processors, acquiring context data corresponding to the state of a target processor immediately before the debug execution code is executed in the target processor, among the multiple parallel processors, and analyzing the context data, thereby performing debugging of a program executed in the processor in which the debug execution code is executed.

Here, the debug execution code may include a break instruction for suspending execution of the program and a handler program for generating an interrupt for passing a control flow to the debugger software.

Here, the target processor may suspend execution of the program in compliance with the break instruction and store the context data in a context memory buffer in main memory based on execution of the handler program.

Here, the context data may be stored at a location assigned to match the identifier of the target processor in the context memory buffer.

Here, the target processor may store the address value of the break instruction in an internal register, and when the handler program is terminated, the target processor may resume the suspended execution of the program based on the address value stored in the internal register.

Here, the handler program may generate the interrupt and thereby notify the debugger software of the fact that execution of the program is suspended in the target processor, and the handler program may be terminated when the interrupt is cleared by the debugger software.

Here, when the interrupt is received, the debugger software may acquire the context data from the context memory buffer and analyze the context data.

Here, the debugger software may generate the program execution binary including the debug execution code by inserting the debug execution code at a breakpoint set by a user for debugging in a general program execution binary, which is generated by compiling a source program.

Here, the method may further include replacing, by the debugger software, the program execution binary including the debug execution code by deleting the debug execution code inserted at the breakpoint and again inserting the debug execution code at a new breakpoint set by a user.

Here, the method may further include, when execution of new code for debugging is requested by a user, generating, by the debugger software, new code including the break instruction at the end of the code and storing, by the debugger software, the new code in a debug code memory buffer in main memory; and storing, by the debugger software, an address value corresponding to the start location of the new code in the internal register.

Here, the target processor may execute the new code based on the address value stored in the internal register when the handler program is terminated.

Also, an apparatus for debugging according to an embodiment of the present disclosure includes a host processor including debugger software configured to generate a program execution binary including debug execution code, to provide the program execution binary to multiple parallel processors, to acquire context data corresponding to the state of a target processor immediately before the debug execution code is executed in the target processor, among the multiple parallel processors, to analyze the context data, and to perform debugging of a program executed in the processor in which the debugging execution code is executed; and main memory shared between the host processor and the multiple parallel processors.

Here, the debug execution code may include a break instruction for suspending execution of the program and a handler program for generating an interrupt for passing a control flow to the debugger software.

Here, the target processor may suspend execution of the program in compliance with the break instruction and store the context data in a context memory buffer in the main memory based on execution of the handler program.

Here, the context data may be stored at a location assigned to match the identifier of the target processor in the context memory buffer.

Here, the target processor may store the address value of the break instruction in an internal register, and when the handler program is terminated, the target processor may resume the suspended execution of the program based on the address value stored in the internal register.

Here, the handler program may generate the interrupt and thereby notify the debugger software of the fact that execution of the program is suspended in the target processor, and the handler program may be terminated when the interrupt is cleared by the debugger software.

Here, when the interrupt is received, the debugger software may acquire the context data from the context memory buffer and analyzes the context data.

Here, the debugger software may generate the program execution binary including the debug execution code by inserting the debug execution code at a breakpoint set by a user for debugging in a general program execution binary, which is generated by compiling a source program.

Here, the debugger software may replace the program execution binary including the debug execution code by deleting the debug execution code inserted at the breakpoint and by again inserting the debug execution code at a new breakpoint requested by the user.

Here, when execution of new code for debugging is requested by a user, the debugger software may generate new code including the break instruction at the end of the code, store the new code in a debug code memory buffer in the main memory, and store an address value corresponding to the start location of the new code in the internal register.

Here, the target processor may execute the new code based on the address value stored in the internal register when the handler program is terminated.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of a conventional hardware debug module (RISC-V debug support specification);

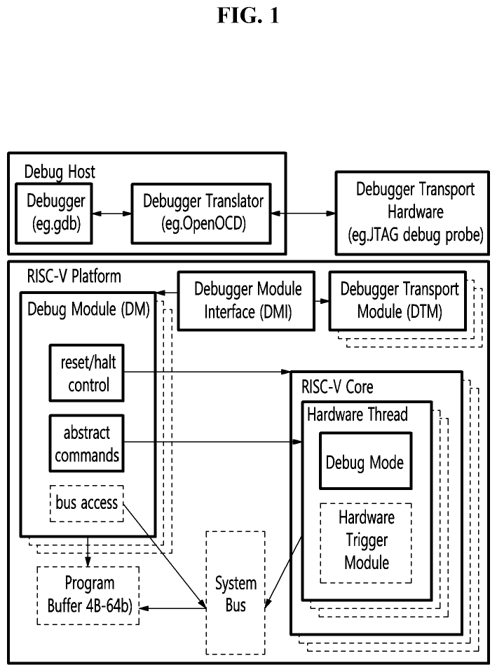

FIG. 2 is a view illustrating an example of a debugging system according to the present disclosure;

FIG. 3 is a flowchart illustrating a method for debugging a program of many core parallel processors based on code execution according to an embodiment of the present disclosure;

FIG. 4 is a flowchart illustrating an example of a process of providing a program execution binary to parallel processors according to the present disclosure;

FIG. 5 is a flowchart illustrating a process of debugging a program of many core parallel processors according to the present disclosure;

FIG. 6 is a flowchart illustrating an example of a process of executing new code for debugging according to the present disclosure;

FIG. 7 is a view structurally illustrating a process of debugging a program of many core parallel processors according to the present disclosure; and

FIG. 8 is a view illustrating a debugging apparatus according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

A function of debugging a program executed in a processor core is a boon to software developers, but the frequency of use thereof is very low when the processor is actually used. In a single processor core, only a single hardware debug module is required to be implemented for the single core, so the implementation area is not large. However, in the case of many core parallel processors for performing parallel processing using thousands of processors, the cost for implementing a hardware debug module (area, wiring, and the like) is a serious problem.

Accordingly, the present disclosure proposes a method that enables debugging of respective programs executed in thousands of parallel processors without implementing a hardware debug module.

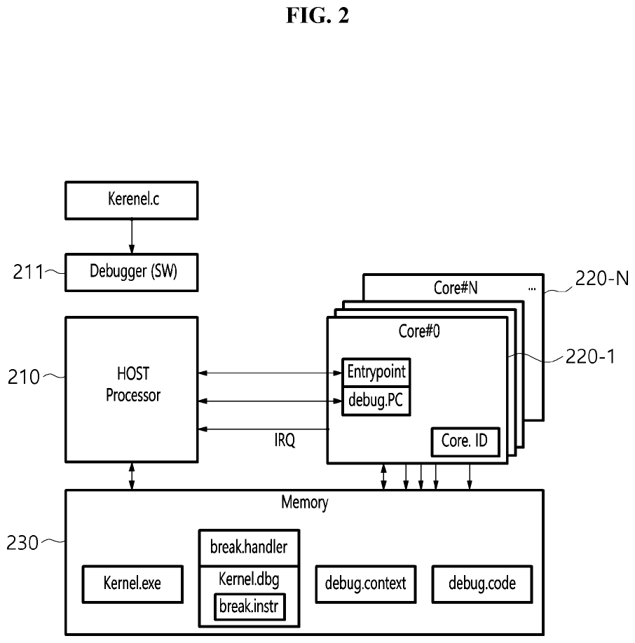

FIG. 2 is a view illustrating an example of a debugging system according to the present disclosure.

Referring to FIG. 2, the debugging system according to the present disclosure may include a host processor 210 on which debugger software 211 is run, multiple parallel processors 220-1 to 220-N, and main memory 230 shared between the host processor 210 and the multiple parallel processors 220-1 to 220-N.

Hereinafter, function blocks configuring respective modules and the roles of the respective function blocks will be described using Table 1 below.

TABLE 1

| Function block | Description |
|---|---|
| Kernel.c | source code of a program executed in multiple |
| | parallel processors Core#0 to Core#N |
| Debugger (SW) | debugging software executed in a host processor |
| | and provided for software programmers |
| HOST Processor | a host processor in which an OS, user |
| | applications, and a debugger (SW) are executed |
| Core#0-Core#N | manycore parallel processors for executing a |
| | program corresponding to Kernel.c in parallel |
| | in order to accelerate an enormous amount of |
| | operation processing |
| Memory | system main memory shared between the host |
| | processor and the multiple parallel processors |
| | Core#0 to Core#N |
| Kernel.exe | a program execution binary generated by |
| | compiling the source code ‘kernel.c’ |
| kernel.dbg | a program execution binary generated by |
| | inserting break.instr into the execution |
| | binary ‘Kernel.exe’ and adding |
| | break.handler code thereto |
| break.instr | one of instructions executed in the multiple |
| | parallel processors Core#0 to Core#N |
| | when this instruction is executed, the |
| | program being executed is suspended and |
| | the break.handler program is executed. |
| break.handler | a program (included in the binary ‘Kernel.dbg’) |
| | executed in response to break.instr in |
| | the multiple parallel processors Core#0 |
| | to Core#N after execution of break.handler |
| | is finished, a program corresponding to the |
| | address stored in debug.PC is executed. |
| debug.context | a memory buffer for storing context data |
| | pertaining to the state of a core immediately |
| | before break.instr is executed in the core, |
| | in which break.instr and break.handler are |
| | executed |
| | the content of general purpose registers, |
| | stacks, and the like of cores that |
| | perform debugging is stored therein |
| debug.code | a memory buffer for storing program code to |
| | be executed by a specific core when a debugging |
| | process of a debugger (SW) is performed |
| Entrypoint | the address value of a program to be initially |
| | executed by each of the multiple parallel |
| | processors Core#0 to Core#N |
| | when a host processor writes an address |
| | value to an entrypoint register, a |
| | corresponding core starts a program from |
| | the entrypoint |
| debug.PC | when break.instr is executed, the PC value |
| | (instruction address) of break.instr is |
| | stored in debug.PC, and after execution of |
| | break.handler program is finished, execution |
| | of a program is resumed from the address |
| | stored in debug.PC |
| Core.ID | a register in a core for storing an ID value |
| | for identifying each of the multiple parallel |
| | processors Core#0 to Core#N |
| | the running core can be identified by checking |
| | Core.ID value in the Kernel program. |

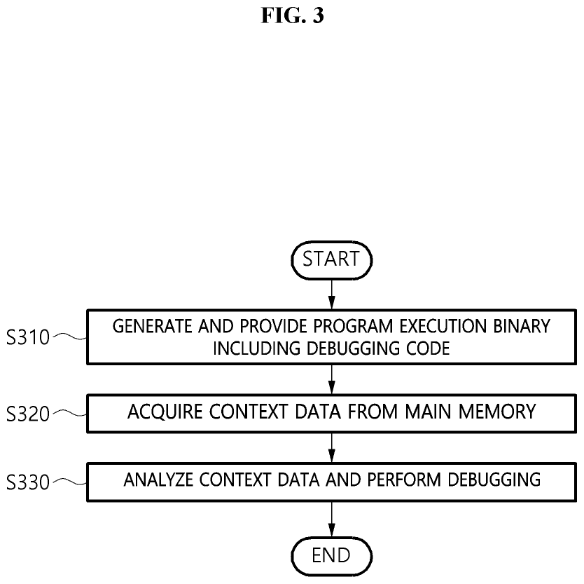

FIG. 3 is a flowchart illustrating a method for debugging a program of many core parallel processors based on code execution according to an embodiment of the present disclosure.

Referring to FIG. 3, in the method for debugging a program of many core parallel processors based on code execution according to an embodiment of the present disclosure, debugger software running on a host processor generates a program execution binary including debug execution code and provides the same to the multiple parallel processors at step S310.

Here, the debugger software inserts debug execution code at a breakpoint set by a user for debugging in the execution binary of a general program, which is generated by compiling a source program, thereby generating a program execution binary including the debug execution code.

For example, the debugger software 211 run on the host processor 210 by a user, illustrated in FIG. 2, compiles the source program ‘Kernel.c’, thereby generating a binary ‘Kernel.exe’ having a form such as that illustrated in Table 2.

TABLE 2

//Kernel.exe
Instruction.0
Instruction.1
Instruction.2
Instruction.3
Instruction.4
Instruction.5
...

Subsequently, the debugger software 211 illustrated in FIG. 2 inserts break.instr at the location corresponding to the breakpoint set by the user in the binary ‘kernel.exe’ illustrated in Table 2 and adds the code of break.handler thereto, as shown in Table 3, thereby generating a binary ‘Kernel.dbg’ including debug execution code.

TABLE 3

//Kernel.dbg
Instruction.0
Instruction.1
Instruction.2
Instruction.3
Instruction.4
break.instr
Instruction.5
...
//break.handler
Save Core context to debug.context
Send IRQ to Host
Wait for IRQ cleared
Set PC <− debug.PC
Continue execution

Here, the debug execution code may include a break instruction for suspending execution of the program and a handler program for generating an interrupt for passing a control flow to the debugger software.

For example, referring to Table 3, break.instr may correspond to a break instruction, and break.handler may correspond to the code of a handler program.

Here, after it respectively loads ‘kernel.exe’, which is the execution binary of a general program that does not include debug execution code, and ‘kernel.dbg’, which is a program execution binary including debug execution code, into main memory, the debugger software according to an embodiment of the present disclosure may set the entrypoint of each processor by separating a processor to perform debugging and a processor that does not perform debugging, among the multiple parallel processors.

For example, the debugger software 211 illustrated in FIG. 2 may load the binary data of ‘Kernel.exe’ that does not include debug execution code and the binary data of ‘Kernel.dbg’ including debug execution code into the main memory 230. Then, the entrypoint register of a processor that does not perform debugging, among the multiple parallel processors 220-1 to 220-N, may be set to store the start address of the binary ‘Kernel.exe’, and the entrypoint register of the core to perform debugging, among the multiple parallel processors 220-1 to 220-N, may be set to store the start address of the binary ‘Kernel.dbg’.

Accordingly, the processor that does not perform debugging executes the binary ‘Kernel.exe’, whereby the program may be executed without interruption. Also, the processor to perform debugging executes the binary ‘Kernel.dbg’, and may suspend execution of the program when it meets break.instr.

Also, in the method for debugging a program of many core parallel processors based on code execution according to an embodiment of the present disclosure, the debugger software acquires context data corresponding to the state of a target processor immediately before the debug execution code is executed, the target processor being a processor in which the debug execution code is executed, among the multiple parallel processors, at step S320.

Here, the target processor may suspend execution of the program in compliance with the break instruction and store the context data in the context memory buffer in the main memory based on execution of the handler program.

Here, the context data may be stored at the location assigned to match the identifier of the target processor in the context memory buffer.

For example, referring to FIG. 2, when it meets a break instruction (break.instr) while executing the program, the target processor may suspend execution of the program, store the address value (the PC value) of the break instruction (break.instr) in the internal debug.PC register thereof, and execute the code of the handler program (break.handler). Subsequently, in the handler program (break.handler), context data, such as the content of general-purpose registers, a stack, debug.PC, and the like of the target processor immediately before the break instruction (break.instr) is executed, may be stored in the context memory buffer (debug.context). Here, using the value of Core.ID corresponding to the target processor, the context data may be stored at the location assigned to the target processor in the debug.context memory buffer.

Here, the handler program generates an interrupt, thereby notifying the debugger software of the fact that execution of the program is suspended in the target processor. Subsequently, the handler program may be terminated when the interrupt is cleared by the debugger software.

For example, the handler program (break.handler) illustrated in FIG. 2 generates an interrupt (IRQ), thereby notifying the debugger software 211 of the host processor 210 of the fact that the target processor suspends execution of the program. Then, the handler program (break.handler) may wait in an idle state until the IRQ is cleared.

Also, in the method for debugging a program of many core parallel processors based on code execution according to an embodiment of the present disclosure, the debugger software analyzes the context data, thereby performing debugging of the program executed in the processor in which the debug execution code is executed at step S330.

Here, when an interrupt is received, the debugger software acquires the context data from the context memory buffer, thereby performing analysis.

For example, the debugger software 211 receiving the IRQ may acquire the context data from the context memory buffer (debug.context) in the main memory 230 and perform analysis thereon. Here, the user of the host processor 210 may check the analysis result and perform debugging of the process after that, and, in this process, the values of program variables and the like may be analyzed.

Here, the target processor may store the address value of the break instruction in the internal register thereof, and may resume the suspended execution of the program based on the address value stored in the internal register when the handler program is terminated.

For example, break.handler illustrated in FIG. 2 sets the value of debug.PC as the PC value in a hardware manner after the operation thereof is finished, whereby the control flow may be returned to the instruction at the location corresponding to the address value stored in debug.PC.

Subsequently, the target processor resumes execution of the program using the program execution binary, and may continue execution of instructions until it meets break.instr.

Here, the debugger software may replace the program execution binary including debug execution code by deleting the debug execution code, which was inserted at the breakpoint, and by again inserting the debug execution code at a new breakpoint in response to a user request.

For example, when the user of the host processor additionally requests functions such as step, step-in, step-out, breakpoint at function, and the like, the debugger software 211 illustrated in FIG. 2 may delete break.instr from the binary ‘Kernel.dbg’ illustrated in Table 3. Subsequently, the debugger software 211 may generate a new binary ‘Kernel.dbg’ by again inserting break.instr at a breakpoint newly requested by the user. The newly generated binary ‘Kernel.dbg’ may be loaded into the main memory 230 so as to replace Kernel.dbg stored therein.

Here, when execution of new code for debugging is requested by a user, the debugger software may generate new code including a break instruction at the end of the code, store the same in a debug code memory buffer in the main memory, and store the address value corresponding to the start location of the new code in the internal register.

Here, when the handler program is terminated, the target processor may execute the new code corresponding to the address value stored in the internal register.

For example, when a user requests execution of additional new code for debugging, the debugger software 211 illustrated in FIG. 2 may generate new code (debug.code) so as to have a structure such as that illustrated in Table 4 and store the same in the debug code memory buffer in the main memory 230. Subsequently, break.instr is inserted as the last instruction of the new code (debug.code) such that the control flow is returned to the debugger software 211 after execution of the new code (debug.code).

TABLE 4

//debug.code
{
...
Instructions
...
break.instr
}

Here, after it stores the new code (debug.code) in the debug code memory buffer of the main memory, the debugger software 211 may set the value of debug.PC of the target processor to the address value of the start location of the new code (debug.code). Subsequently, the handler program (break.handler) may be terminated by clearing the IRQ, and after the handler program (break.handler) is terminated, the instruction at the address indicated by the value of debug.PC is executed, whereby instructions in the new code (debug.code) may be executed in the target processor.

Through the above-described method for debugging a program of many core parallel processors based on code execution, debugging of a program of each of parallel processors may be performed without a hardware debug module in a large-scale parallel system in which thousands or more processors are used.

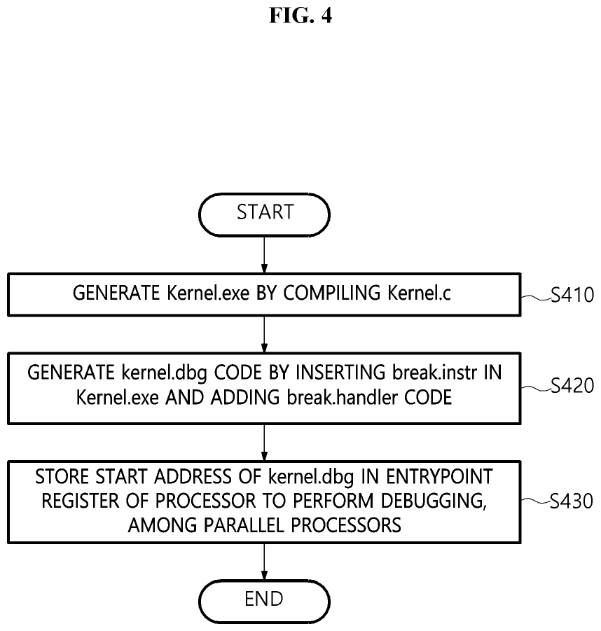

FIG. 4 is a flowchart illustrating an example of a process of providing a program execution binary to parallel processors according to the present disclosure.

Referring to FIG. 4, in the process of providing a program execution binary to parallel processors according to the present disclosure, first, debugger software run on a host processor by a user may generate a binary ‘Kernel.exe’ having a form such as that illustrated in Table 2 by compiling a source program ‘kernel.c’ at step S410.

Subsequently, the debugger software inserts break.instr at a breakpoint set by the user in the binary ‘Kernel.exe’ illustrated in Table 2 and adds the code of break.handler, as shown in Table 3, thereby generating binary code ‘kernel.dbg’ including debug execution code at step S420.

Subsequently, the start address of the binary ‘kernel.dbg’ may be stored in the entrypoint register of the processor to perform debugging, among the multiple parallel processors, at step S430.

Through the above-described process, the processor to perform debugging may execute the binary ‘Kernel.dbg’, and may suspend execution of the program when it meets break.instr.

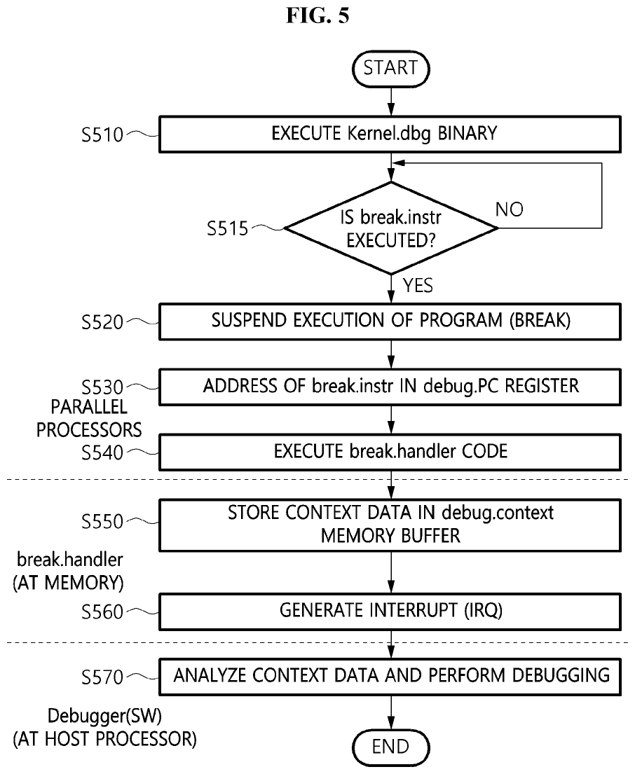

FIG. 5 is a flowchart illustrating a process of debugging a program of many core parallel processors according to the present disclosure.

Referring to FIG. 5, the process of debugging a program of many core parallel processors according to the present disclosure may be divided into an operation of parallel processors, an operation of a handler program (break.handler), and an operation of debugger software.

First, among parallel processors, a target processor, the entrypoint register of which stores the start address of the binary ‘kernel.dbg’ through the process illustrated in FIG. 4, may execute the binary ‘kernel.dbg’ at step S510, and may determine whether break.instr is executed while the program is being executed at step S515.

When it is determined at step S515 that break.instr is not executed, the program continues to be executed, and while the program is being executed, whether break.instr is executed may be determined.

Also, when it is determined at step S515 that break.instr is executed, execution of the program is suspended at step S520, the address value (the PC value) of break.instr is stored in the internal debug.PC register at step S530, and the code of a handler program (break.handler) may be executed at step S540.

Subsequently, the handler program (break.handler) may store context data, such as the content of general purpose registers, a stack, debug.PC, and the like of the target processor immediately before the break instruction (break.instr) is executed, in a context memory buffer (debug. context) at step S550.

Here, the handler program generates an interrupt, thereby notifying the debugger software of the fact that execution of the program is suspended in the target processor at step S560.

Subsequently, the debugger software analyzes the context data, thereby debugging the program executed in the processor in which the debug execution code is executed at step S570.

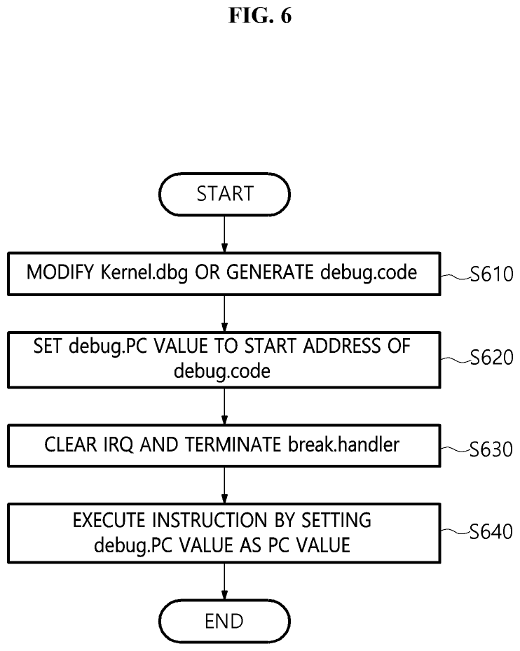

FIG. 6 is a flowchart illustrating an example of a process of executing new code for debugging according to the present disclosure.

Referring to FIG. 6, in the process of executing new code for debugging according to the present disclosure, first, when a user requests execution of additional new code for debugging, debugger software may generate new code (debug.code) so as have a structure such as that illustrated in Table 4 at step S610.

Here, break.instr is inserted as the last instruction of the new code (debug.code), whereby the control flow may be returned to the debugger software after execution of the new code (debug.code).

Subsequently, the debugger software may store the new code (debug.code) in a debug code memory buffer of main memory, and may set the value of debug.PC of a target processor to the start address value of the new code (debug.code) at step S620.

Subsequently, the handler program (break.handler) may be terminated by clearing the IRQ at step S630, and after the handler program (break.handler) is terminated, the instruction at the address indicated by the value of debug.PC is executed, whereby instructions in the new code (debug.code) may be executed in the target processor at step S640.

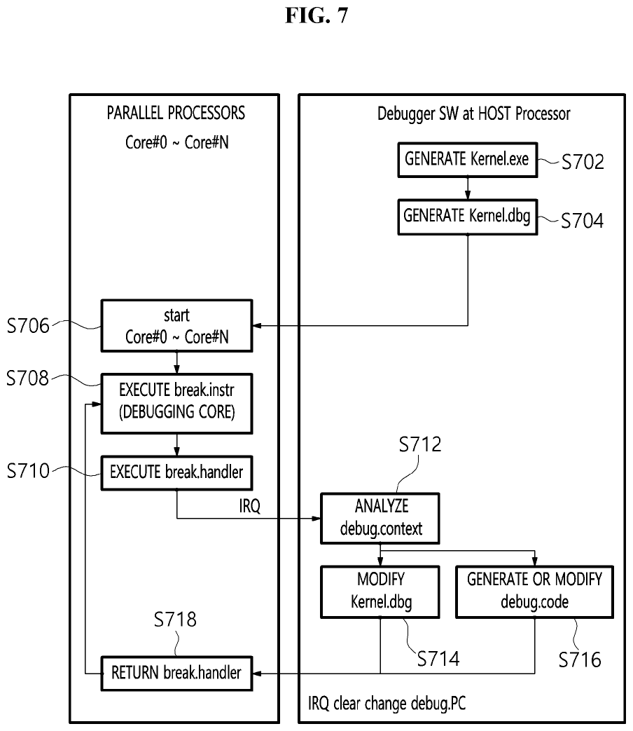

FIG. 7 is a view structurally illustrating a process of debugging a program of many core parallel processors according to the present disclosure.

Referring to FIG. 7, in the process of debugging a program of many core parallel processors according to the present disclosure, first, debugger software running on a host processor compiles the source program ‘Kernel.c’, thereby generating a binary ‘Kernel.exe’ having a form such as that illustrated in Table 2 at step S702.

Subsequently, the debugger software inserts break.instr at a breakpoint set by a user in the binary ‘Kernel.exe’ illustrated in Table 2 and adds the code of break.handler, as shown in Table 3, thereby generating a binary ‘Kernel.dbg’ including debug execution code at step S704.

Subsequently, the debugger software may provide the binary ‘Kernel.dbg’ to multiple parallel processors Core#0 to Core#N, and the multiple parallel processors may execute the program by setting the start address of the binary ‘Kernel.dbg’ as the value of the entrypoint register thereof at step S706.

Subsequently, when break.instr is met during execution of the program, execution of the program is suspended, and a handler program (break.handler) may be executed at step S710.

Here, the handler program generates an interrupt (IRQ), thereby notifying the debugger software of the fact that execution of the program is suspended.

Subsequently, the debugger software analyzes context data at step S712, after which the debugger software may modify the binary ‘Kernel.dbg’ in response to a user request at step S714 or generate and execute new code (debug.code) at step S716.

For example, when the user of the host processor additionally requests functions such as step, step-in, step-out, breakpoint at function, and the like, the debugger software may delete break.instr from the binary ‘Kernel.dbg’. Subsequently, the debugger software may modify the binary ‘Kernel.dbg’ by again inserting break.instr at a breakpoint newly requested by the user. The modified binary ‘Kernel.dbg’ may be loaded into the main memory so as to replace Kernel.dbg stored therein.

In another example, when a user requests execution of additional new code for debugging, the debugger software may generate new code (debug.code) so as to have a structure such as that illustrated in Table 4 and store the same in a debug code memory buffer of the main memory. Subsequently, break.instr is inserted as the last instruction of the new code (debug.code), whereby the control flow may be returned to the debugger software after execution of the new code (debug.code).

Subsequently, the IRQ is cleared such that the handler program (break.handler) is terminated, and after the handler program (break.handler) is terminated, the instruction at the address indicated by the value of debug.PC is executed, whereby the control flow may be returned to the instruction at the address indicated by the value of debug.PC at step S718.

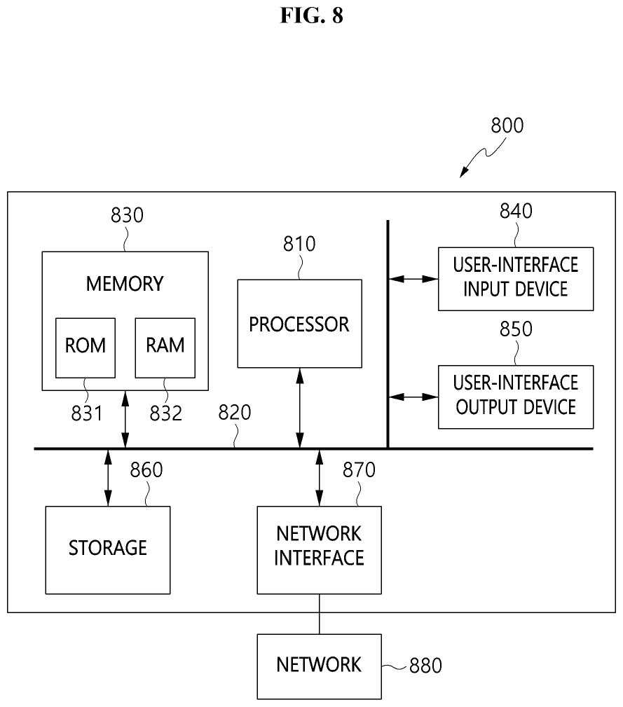

FIG. 8 is a view illustrating a debugging apparatus according to an embodiment of the present disclosure.

Referring to FIG. 8, the debugging apparatus according to an embodiment of the present disclosure may be implemented in a computer system including a computer-readable recording medium. As illustrated in FIG. 8, the computer system 800 may include one or more processors 810, memory 830, a user-interface input device 840, a user-interface output device 850, and storage 860, which communicate with each other via a bus 820. Also, the computer system 800 may further include a network interface 870 connected to a network 880. The processor 810 may be a central processing unit or a semiconductor device for executing processing instructions stored in the memory 830 or the storage 860. The memory 830 and the storage 860 may be any of various types of volatile or nonvolatile storage media. For example, the memory may include ROM 831 or RAM 832.

Accordingly, an embodiment of the present disclosure may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present disclosure.

Here, the processor 810 may be a host processor of the present disclosure.

The processor 810 may include debugger software configured to generate a program execution binary including debug execution code, to provide the program execution binary to multiple parallel processors, to acquire context data corresponding to the state of a target processor immediately before the debug execution code is executed in the target processor, among the multiple parallel processors, and to analyze the context data so as to perform debugging of the program executed in the processor in which the debug execution code is executed.

Here, the debugger software may generate the program execution binary including debug execution code by inserting the debug execution code at a breakpoint set by a user for debugging in the execution binary of a general program, which is generated by compiling a source program.

Here, the debug execution code may include a break instruction for suspending execution of the program and a handler program for generating an interrupt for passing a control flow to the debugger software.

Here, the debugger software according to an embodiment of the present disclosure may load a general program execution binary (kernel.exe) that does not include debug execution code and a program execution binary (kernel.dbg) including debug execution code into main memory, and may set the entrypoint of each of the processors by separating a processor to perform debugging and a processor that does not perform debugging, among the multiple parallel processors.

Here, the target processor may suspend execution of the program in compliance with the break instruction, and may store the context data in a context memory buffer in the main memory based on execution of the handler program.

Here, the context data may be stored at the location assigned to match the identifier of the target processor in the context memory buffer.

Here, the handler program may generate an interrupt and notify the debugger software of the fact that execution of the program is suspended in the target processor, and the handler program may be terminated when the interrupt is cleared by the debugger software.

Here, upon receiving the interrupt, the debugger software may acquire the context data from the context memory buffer and analyze the same.

Here, the target processor may store the address value of the break instruction in the internal register thereof, and may resume the suspended execution of the program based on the address value stored in the internal register when the handler program is terminated.

Here, the debugger software deletes the debug execution code inserted at the breakpoint and again inserts the debug execution code at a new breakpoint requested by a user, thereby replacing the program execution binary including the debug execution code.

Here, when a user requests execution of new code for debugging, the debugger software may generate new code including a break instruction at the end of the code, store the same in a debug code memory buffer in the main memory, and store the address value corresponding to the start location of the new code in an internal register.

Here, the target processor may execute the new code using the address value stored in the internal register when the handler program is terminated.

Using the above-described debugging apparatus, debugging of a program of each of parallel processors may be performed without a hardware debug module in a large-scale parallel system in which thousands and more processors are used.

According to the present disclosure, debugging of a program of each of parallel processors may be performed without a hardware debug module in a large-scale parallel system in which thousands and more processors are used.

As described above, the method for debugging a program of many core parallel processors based on code execution and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for debugging a program of many core parallel processors, which is performed by debugger software running on a host processor, comprising:
generating a program execution binary including debug execution code and providing the program execution binary to multiple parallel processors;
acquiring context data corresponding to a state of a target processor immediately before the debug execution code is executed, the target processor being a processor in which the debug execution code is executed, among the multiple parallel processors; and
analyzing the context data, thereby performing debugging of a program executed in the processor in which the debug execution code is executed.

2. The method of claim 1, wherein the debug execution code includes a break instruction for suspending execution of the program and a handler program for generating an interrupt for passing a control flow to the debugger software.

3. The method of claim 2, wherein the target processor suspends execution of the program in compliance with the break instruction and stores the context data in a context memory buffer in main memory based on execution of the handler program.

4. The method of claim 3, wherein the context data is stored at a location assigned to match an identifier of the target processor in the context memory buffer.

5. The method of claim 2, wherein the target processor stores an address value of the break instruction in an internal register, and when the handler program is terminated, the target processor resumes the suspended execution of the program based on the address value stored in the internal register.

6. The method of claim 5, wherein the handler program generates the interrupt and thereby notifies the debugger software of a fact that execution of the program is suspended in the target processor, and the handler program is terminated when the interrupt is cleared by the debugger software.

7. The method of claim 3, wherein, when the interrupt is received, the debugger software acquires the context data from the context memory buffer and analyzes the context data.

8. The method of claim 1, wherein the debugger software generates the program execution binary including the debug execution code by inserting the debug execution code at a breakpoint set by a user for debugging in a general program execution binary generated by compiling a source program.

9. The method of claim 8, further comprising:
replacing, by the debugger software, the program execution binary including the debug execution code by deleting the debug execution code inserted at the breakpoint and by again inserting the debug execution code at a new breakpoint requested by the user.

10. The method of claim 5, further comprising:
when execution of new code for debugging is requested by a user, generating, by the debugger software, new code including the break instruction at an end of the code and storing, by the debugger software, the new code in a debug code memory buffer in main memory; and
storing, by the debugger software, an address value corresponding to a start location of the new code in the internal register.

11. The method of claim 10, wherein the target processor executes the new code based on the address value stored in the internal register when the handler program is terminated.

12. A debugging apparatus, comprising:
a host processor including debugger software configured to generate a program execution binary including debug execution code, to provide the program execution binary to multiple parallel processors, to acquire context data corresponding to a state of a target processor immediately before the debug execution code is executed, the target processor being a processor in which the debug execution code is executed, among the multiple parallel processors, to analyze the context data, and to perform debugging of a program executed in the processor, in which the debugging execution code is executed; and
main memory shared between the host processor and the multiple parallel processors.

13. The debugging apparatus of claim 12, wherein the debug execution code includes a break instruction for suspending execution of the program and a handler program for generating an interrupt for passing a control flow to the debugger software.

14. The debugging apparatus of claim 13, wherein the target processor suspends execution of the program in compliance with the break instruction and stores the context data in a context memory buffer in the main memory based on execution of the handler program.

15. The debugging apparatus of claim 14, wherein the context data is stored at a location assigned to match an identifier of the target processor in the context memory buffer.

16. The debugging apparatus of claim 13, wherein the target processor stores an address value of the break instruction in an internal register, and when the handler program is terminated, the target processor resumes the suspended execution of the program based on the address value stored in the internal register.

17. The debugging apparatus of claim 16, wherein the handler program generates the interrupt and thereby notifies the debugger software of a fact that execution of the program is suspended in the target processor, and the handler program is terminated when the interrupt is cleared by the debugger software.

18. The debugging apparatus of claim 14, wherein, when the interrupt is received, the debugger software acquires the context data from the context memory buffer and analyzes the context data.

19. The debugging apparatus of claim 12, wherein the debugger software generates the program execution binary including the debug execution code by inserting the debug execution code at a breakpoint set by a user for debugging in a general program execution binary generated by compiling a source program.

20. The debugging apparatus of claim 19, wherein the debugger software replaces the program execution binary including the debug execution code by deleting the debug execution code inserted at the breakpoint and again inserting the debug execution code at a new breakpoint requested by the user.
